(19) United States
(12) Patent Application Publication
(10) Pub. No.: US 2009/0298594 A1
(43) Pub. Date: Dec. 3, 2009

(54) MEDIA/TAG-BASED WORD GAMES

(75) Inventors: Lluis Garcia Pueyo, Barcelona (ES); Borkur Sigurbjornsson, Barcelona (ES); Simon E. Overell, London (GB); Vanessa Murdock, Barcelona (ES); Roelof Van Zwol, Badalona (ES)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/128,278

(22) Filed: May 28, 2008

(51) Int. Cl. A63F 9/24; A63F 13/12

(52) U.S. Cl. 463/42; 463/9; 463/43

(57) ABSTRACT

A method of creating a word game comprising receiving a seed value from a browser, obtaining from a media database a plurality of words associated with the seed value, creating a word game from at least a subset of the obtained plurality of words, integrating the word game into a browser interpretable document, and, returning the browser interpretable document to the browser. Some embodiments further comprise incorporating into the browser interpretable document an advertisement associated with the seed value and/or at least one of the obtained plurality of words. Also disclosed is a system comprising a gaming server which receives a game request; a media server and media tag database; the gaming server requesting from the media server a set of media tags associated with a game seed value, building a word game using at least a subset of the media tags, and transmitting the word game.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of online games, and more particularly provides a system and methods for leveraging media and associated tags to create a game.

### BACKGROUND

Word games have been popular for a long time. From classics such as find-a-word, crossword puzzles, and hangman, to more unusual games such as jumble, word games can provide an entertaining distraction and help develop vocabulary and other language skills.

### SUMMARY

Traditional word games are played by an author/creator (referred to as “creator” for clarity) selecting one or more words and applying the selected word(s) to the game. While the games are exciting for those who play them, it is always necessary for someone to create new games. There is a disincentive for persons who enjoy playing word games to create their own games, because the game creator inherently knows the answers to the game. The instant disclosure is directed to the creation of one or more word games based on media tags. The underlying game engine substantially obviates one or more of the problems due to limitations and disadvantages of the related art.

The instant disclosure allows users to generate visual word puzzles for their own enjoyment, and which can also be embedded in their homepage, in a blog, for use as a Facebook applet, or the like. The integration into third party web sites allows additional incoming traffic to be generated to social media properties. For users, it provides additional value to participating in social media activities, in the sense that they can easily use the word games to promote/show off their own media objects. Furthermore, the gaming engine and games created thereby provide an incentive for users to provide accurate tags with their media objects when sharing.

In some embodiments, the user begins by supplying a seed word or user ID (collectively “seed value”), which is used to generate a new puzzle. A seed word may include a word, phrase, or set of words/phrases. By way of example, without limitation, the following are sample seed words:

### “Zoo”, “la Sagrada Familia”, and “Torre Agbar, Barcelona”.

The seed word can be formulated just as tags are specified for a media file in a media database. The latter set of words in the example is an illustration of a seed word that is composed of two tags separated by a comma, whereas the first two topics consist of a single seed word.

In some embodiments, once a seed value is provided, a puzzle or other game is generated and shown to the user. In some embodiments, a game consists of a set of tags, a set of photos, and a game type. The set of tags contains tags related to the seed value that is used to generate the game. For each tag in the set, there is a corresponding photo annotated by the tag. In some embodiments, clicking on the photo allows the user to obtain additional information about the media file.

In embodiments implementing a hidden word game, a timer starts counting down from 90 seconds when the game is loaded. The user can search for words in the puzzle, and can highlight them by pointing with the mouse and dragging from the first letter to the last. In some embodiments, every time a word (tag) is found, the user gets additional seconds to complete the puzzle. The game stops when all words in the puzzle are found, when there is no more time left, or when the user chooses to see the solution of the puzzle. When the game is finished (e.g., when time expires), the complete solution is shown to the user, (FIG. 3), and the user has the option to play another game.

To create a game, a set of tag-photo pairs is selected based on the seed value. When a seed word is provided, a set of related tags is derived using tag co-occurrence statistics that are derived from the annotated photos in the media database. In addition, a plurality of related photos are retrieved from Flickr using the search API, each of the photos being associated with the seed value. For each tag in the set of related tags, a photo is associated with that tag, under the condition that the tag matches one of the tags of the photo. When a username is given, a set of related tags is derived by retrieving a set of photos contributed by or associated with that user, and by calculating a histogram of the tags that have been defined by the user to describe these photos. There are various ways to derive a set of tags and associated photos. In one embodiment, the set of related tags is obtained by selecting from the least frequent and most recently used tags. As described above, for each tag in the set of related tags a photo is associated with that tag, under the condition that the tag matches one of the tags of the photo.

In some embodiments, the layout of a new game is generated by the game server using the following input: A set of tag-photo pairs, the dimensions of the puzzle that should be generated, and the number of tag-photo pairs that will be embedded in the puzzle. The puzzle generator produces a layout of the puzzle. In some embodiments, the game server may also track game and user statistics, high scores, and the like, and may feed social incentives (e.g., credits toward prizes, the credits being awarded upon successful completion of the game).

Additional features and advantages will be set forth in the description which follows, and in part will be apparent from this disclosure, or may be learned by practice thereof. The objectives and other advantages will be realized and attained by the structure particularly pointed out in this written description, including any claims contained herein and the appended drawings.

Some embodiments comprise a method of creating a word game, comprising receiving a seed value from a browser running on a user computer; obtaining from a media database a plurality of words associated with the seed value; creating a word game from at least a subset of the obtained plurality of words; integrating the word game into a browser interpretable document; and returning the browser interpretable document to the browser. Some embodiments further comprise obtaining an advertisement from an advertising server; and, integrating the advertisement into the browser interpretable document. In some embodiments the advertisement is associated with the seed value, and in some embodiments advertisement is associated with at least one of the obtained plurality of words.

Some embodiments further comprise obtaining a media file for each of the at least a subset of the obtained plurality of words used in the word game; and, integrating the obtained media files into the word game as a clue.

In some embodiments, the selected words are used to create a hidden word game. The hidden word game may be created in a variety of manners, including selecting a specific number of words from the obtained plurality of words; arranging the selected words within a matrix; filling in the matrix with random letters; and storing the filled matrix for display via the browser. In some embodiments, the selected words are arranged such that they do not overlap.

In some embodiments, the selected words are used to create a crossword puzzle game. The crossword puzzle game may be created in a variety of manners, including selecting a specific number of words from the obtained plurality of words; arranging the selected words within a matrix; hiding any unfilled portions of the matrix; and storing the arrangement of the filled portions of the matrix for display via the browser.

In some embodiments, the seed value may comprise a seed word and/or a username.

In some embodiments, the method described above can be implemented as computer program process code tangibly stored on a computer readable medium. In such embodiments, the computer program process code may comprise instructions interpretable by a processor, for executing the method.

Some embodiments comprise a system comprising a gaming server, the gaming server receiving a request for a game from a browser running on a user computing device, the request comprising a seed value; a media server, the media server comprising a media tag database, the media tag database having stored therein a plurality of media tags; the gaming server requesting a set of media tags associated with the seed value and building a word game using at least a subset of the media tags and transmitting the word game to the browser as a browser interpretable document. Some embodiments further comprise a advertisement server comprising an advertisement database, the advertisement server providing an advertisement to the gaming server; the gaming server integrating the advertisement into the browser interpretable document. In some embodiments, the advertisement is selected by the advertisement server because it is associated with the seed value and/or at least one of the obtained plurality of words.

In some embodiments, the media server provides a media file for each of the at least a subset of the obtained plurality of words used in the word game; and, the gaming server integrating the obtained media files into the word game as a clue. The gaming server may create a variety of games from the words, including a hidden word game, a crossword puzzle game, a hangman game, and the like.

It is to be understood that both the foregoing general description and the following detailed description are exemplary and explanatory and are intended to provide further explanation of the disclosed media tag game engine.

### BRIEF DESCRIPTION OF THE DRAWINGS

The accompanying drawings, which are included to provide a further understanding of the disclosed media tag game engine and are incorporated in and constitute a part of this specification, illustrate various embodiments and, together with the description, serve to explain the principles of at least one embodiment of the disclosed media tag game engine.

In the drawings:

FIG. 1 is a block diagram illustrating an exemplary computing device.

FIG. 2 is a block diagram illustrating an exemplary network architecture for supporting the instant system and methods.

FIG. 3 is a flow chart illustrating logic that can be applied to a game request.

FIG. 4 is a screen capture illustrating an exemplary game initiation screen.

FIG. 5 is a screen capture illustrating an exemplary word find game at the initiation of the game.

FIG. 6 is a screen capture illustrating an exemplary word find game during the playing of the game.

FIG. 7 is a screen capture illustrating an exemplary word find game after the unsuccessful completion of the game.

FIG. 8 is a screen capture illustrating an exemplary embedding code generation page.

FIG. 9 is a screen capture illustrating an alternative embedding code generation page.

FIG. 10 is a screen capture illustrating an exemplary interface through which a user can be advised that a requested game cannot be generated.

FIG. 11 is a screen capture illustrating an exemplary hangman game during the playing of the game.

FIG. 12 is a screen capture illustrating an exemplary crossword puzzle game at the completion of the game.

### DETAILED DESCRIPTION

Reference will now be made in detail to embodiments of the disclosed media tag game engine, examples of which are illustrated in the accompanying drawings.

For the purposes of this disclosure, a computing device (also referred to herein as a “computer”) includes a processor and memory for storing and executing program code, data and software. Computing devices may be provided with operating systems that allow the execution of software applications in order to manipulate data. Personal computers, PDAs, wireless devices, cell phones, internet appliances, media players, home theater systems, and media centers are several non-limiting examples of computing devices.

For the purposes of this disclosure, a server comprises software and/or hardware running on one or more computing devices which receives information requests from other servers, user computers, or other computing devices, and responds to such requests. A number of program modules and data files may be stored on a computer readable medium of the server. They may include an operating system suitable for controlling the operation of a networked server computer, such as the WINDOWS VISTA, WINDOWS XP, or WINDOWS 2003 operating systems published by Microsoft Corporation of Redmond, Wash., the Ubuntu operating system distributed by Canonical Ldt. of Douglas, Isle of Mann.

For the purposes of this disclosure a media server is software, hardware, or firmware (or combinations thereof) capable of storing media files or pointers thereto, in a database and searching the database or other repository to find relevant media to be served to users. A media server may be a single server or a group of servers acting together. A media server selects media to serve based on a variety of factors including media requested by the user, algorithms meant to direct to the user other content which is relevant to, similar to, or likely to be of interest to the user based on the media requested by the user, and the like. Such media servers may be implemented by a media provider (e.g. Flickr, MySpace, YouTube, and the like), or other service provider (e.g., Yahoo!, Google, Akami, or the like). In some embodiments, the media, or pointers thereto, is served in the form of, or in a form that can be easily incorporated into, a Hypertext Markup Language (“HTML”) document using the Hypertext Transfer Protocol (“HTTP”).

For the purposes of this disclosure an advertising server is software, hardware, or firmware (or combinations thereof) capable of storing data in a database and searching the database or other repository to find relevant advertisements to be served to users. An advertising server may be a single server or a group of servers acting together. An advertising server selects advertisements to serve based on algorithms meant to direct to the user those advertisements which are most relevant to the user or likely to be of interest to the user. Such advertising servers may be implemented by an advertising service provider (e.g. YAHOO! Inc., Google Inc., and the like), or other service provider. In some embodiments, the advertisements are served in the form of, or in a form that can be easily incorporated into, a Hypertext Markup Language (“HTML”) document using the Hypertext Transfer Protocol (“HTTP”).

For the purposes of this disclosure a game server is software, hardware, or firmware (or combinations thereof) capable of receiving input from a user, generating a game based on the received input, and storing at least one of the received input or the generated game in a database or other repository such that the game can be readily played again. A game server may be a single server or a group of servers acting together. Such game servers may be implemented by a service provider (e.g. YAHOO! Inc., Google Inc., AOL, and the like), or other service provider. In some embodiments, the games are served in the form of, or in a form that can be easily incorporated into, a Hypertext Markup Language (“HTML”) document using the Hypertext Transfer Protocol (“HTTP”).

For the purposes of this disclosure the terms “network browsing application” and “browser” are intended to be synonymous and are intended to encompass application software, running on a computing device, which is at least capable of interpreting information stored using Hypertext Markup Language (“HTML”), Extensible Markup Language (“XML”), or other language derived from the Standardized Generalized Markup Language. Examples of such browsers include, but are not limited to, Internet Explorer distributed by Microsoft Corporation; Firefox distributed by the Mozilla Foundation of Mountain View, Calif.; Camino distributed by the Camino Project; and Opera distributed by Opera Software ASA of Oslo, Norway.

For the purposes of this disclosure a computer readable medium stores computer data in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to store the desired information and which can be accessed by the computer.

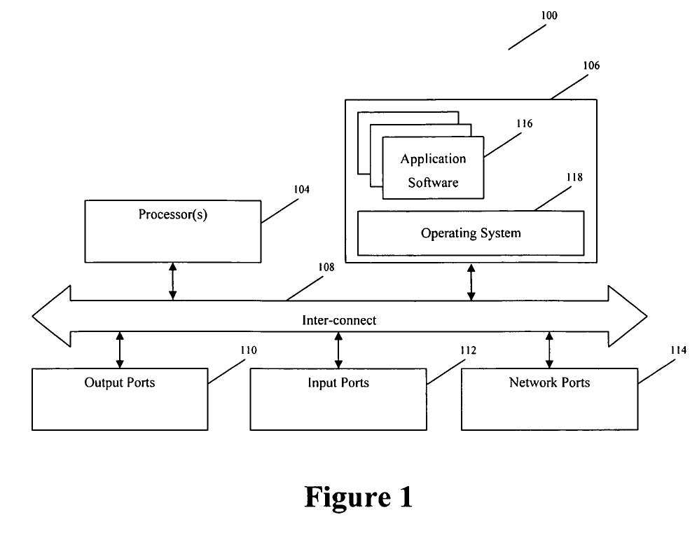

FIG. 1 is a block diagram illustrating components of an exemplary computing device 100. In some embodiments, computing device 100 comprises an inter-connect 108 (e.g., bus, system core logic, or the like), which facilitates communication between the various components of computing device 100 such as, without limitation, processor(s) 104 and memory 106. Furthermore, interconnect 108 can allow processor 104 and/or memory 106 to communicate with peripheral devices, including those connected via input ports 112 and output ports 110. Input ports 112 and output ports 110 can communicate with I/O devices such as mice, keyboards, modems, network interfaces, printers, scanners, video cameras and other devices. In addition, output port 110 can further communicate with a display.

Interconnect 108 may also comprise one or more buses connected to one another through various bridges, controllers and/or adapters. In some embodiments, input ports 112 and output ports 110 can include a USB (Universal Serial Bus) adapter for controlling USB peripherals, and/or an IEEE-1394 bus adapter for controlling IEEE-1394 peripherals. Inter-connect 108 can also include one or more network ports 114, through which the user computing device can be communicatively coupled with a communication network.

In some embodiments, memory 106 may include ROM (Read Only Memory), and volatile RAM (Random Access Memory) and non-volatile memory, such as hard drive, flash memory, computer-readable media, or the like. Volatile RAM is typically implemented as dynamic RAM (DRAM), which requires continuous power to refresh or maintain the data in the memory. Non-volatile memory is typically a magnetic hard drive, flash memory, a magneto-optical drive, or an optical drive (e.g., a DVD RAM), or other type of memory system which maintains data even after power is removed from the system. Computer-readable media can include, without limitation, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), or the like.

In some embodiments, memory 106 can be a local device coupled directly to the other components or modules in the data processing system. A non-volatile memory that is remote from the system, such as a network storage device coupled to the data processing system through a network interface such as a modem or Ethernet interface, can also be used.

In some embodiments, routines executed to implement one or more embodiments may be implemented as part of an operating system 118 or a specific application, component, program, object, module or sequence of instructions, collectively referred to herein as application software 116. Application software 116 typically comprises one or more instruction sets that can be executed by microprocessor 104 to perform operations necessary to execute elements involving the various aspects of the methods and systems described herein.

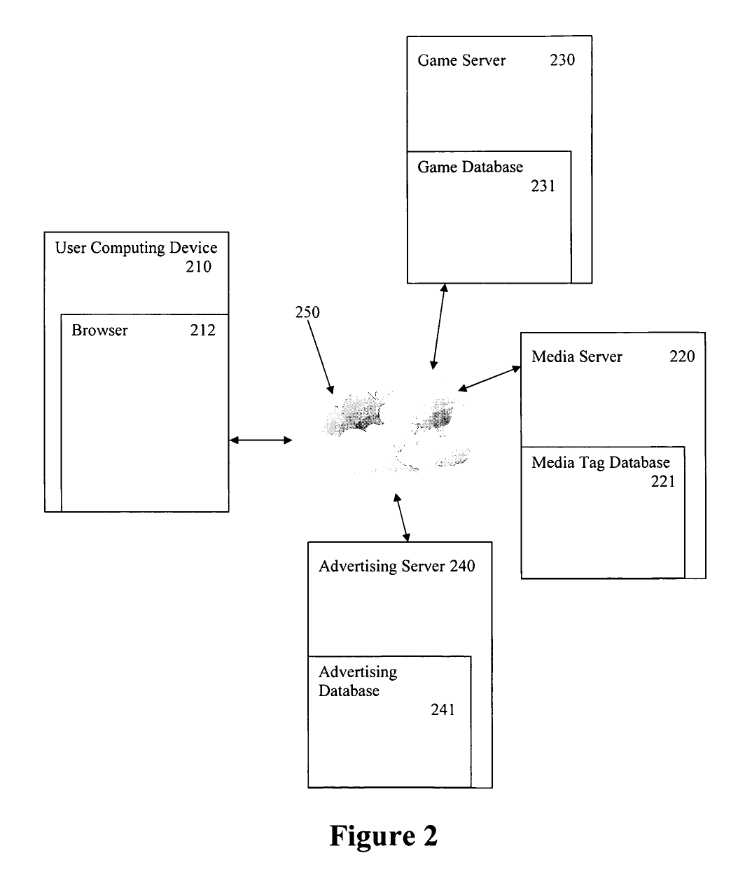

FIG. 2 illustrates a network architecture supporting the disclosed media tag game engine. In FIG. 2, user computing device 210 comprises one or more computer readable media on which browser 212 is stored. A user causes user computing device 210 to load browser 212, thereby allowing the user to access gaming and other services via network 250. Such services can include the media tag game engine provided by game server 230. In some embodiments, game server 230 provides a browser interpretable document, such as, without limitation, a document comprising HTML code, to browser 212 via network 250 when browser 212 initiates communications with server 230, or in response to requests received from browser 212. The browser interpretable document can allow browser 212 to generate a user interface through which the user can perform a variety of tasks, including without limitation, initiating the creation and/or playing of a game.

Media server 220 stores media files and/or links to media files, thereby providing browser 212 with access to the media files. For clarity, the term “media file”, as used herein, is intended to include both media files themselves and pointers to the media files. In some embodiments, at least one media tag, or information about the media, is associated with each media file. Such media tags may be stored in media tag database 221. Although described herein as features and functions provided by a third party service, it should be evident to one skilled in the art that media server 220 can be implemented by a service provider, within a local network, or the like, without departing from the spirit or the scope of the disclosure. By way of example, without limitation, in one embodiment media server 220 is provided by the Flickr service provided by Yahoo!, Inc. However, in some embodiments, media server 220 may be provided by a database residing locally on user computing device 210 (e.g., by the media library associated with iTunes, Windows Media Player, Microsoft Digital Image Pro, or the like).

In some embodiments, media server 220 may provide an application programmer interface (“API”) through which information stored in media tag database 221 may be accessed by computing devices other than media server 220. By way of example, without limitation, the Flickr service allows external applications and servers to access a variety of information from the media database stored therein, including media tag data. Information on the Flickr API can be found at http://www.flickr.com/services/api/.

In some embodiments, in addition to building a game, game server 230 can also allow one or more advertisements to be incorporated into or otherwise associated with the game. Game server 230 can obtain the relevant advertisement from advertisement server 240, which can select the appropriate advertisement from advertisement database 241. The advertisement may be selected based on a number of criteria, including relevancy to a seed word entered by the user or associated with the game, relevancy to one or more words appearing in the game, information derived from a user's social networking or other information, or the like. In some embodiments, advertising server 240 may select an advertisement based solely on the popularity of the advertisement, with little or no regard to the actual relevance of the advertisement to the game. By contrast, in some embodiments, advertising server 240 may select the advertisement based on demographic and/or behavioral information associated with the user's friends. Such friends may be determined through a variety of means, including, without limitation, by analyzing the persons playing other games generated by the user, persons on the user's instant messenger “buddy” list, persons whose names appear in the user's inbox or address book, or by associations between the user and the person(s) in one or more social networking services, such as, without limitation, the services provided by Yahoo! Inc. of Santa Monica, Calif.; LinkedIn Corporation of Mountain View, Calif.; Facebook, Inc. of Palo Alto, Calif.; and MySpace, Inc. of Los Angeles, Calif.

By way of example, without limitation, some embodiments allow a first user to create a game based exclusively on media files contributed by a second user. In such an embodiment, the first user enters the second user's user ID, screen name, or the like, and game server 230 selects a set of tags from those tags associated with media files contributed by the second user. In some embodiments, a media file may be chosen at random from the set of files contributed by the second user, and one or more of the tags associated with that media file can be used as a seed word, in a manner similar to the topic-based games described herein, with the added caveat that the tag and media file searches described below be limited to those tags and media files contributed by the second user. It should be apparent to one skilled in the art that although described above as two discrete users, the first and second user can be the same user without departing from the spirit or the scope of this disclosure.

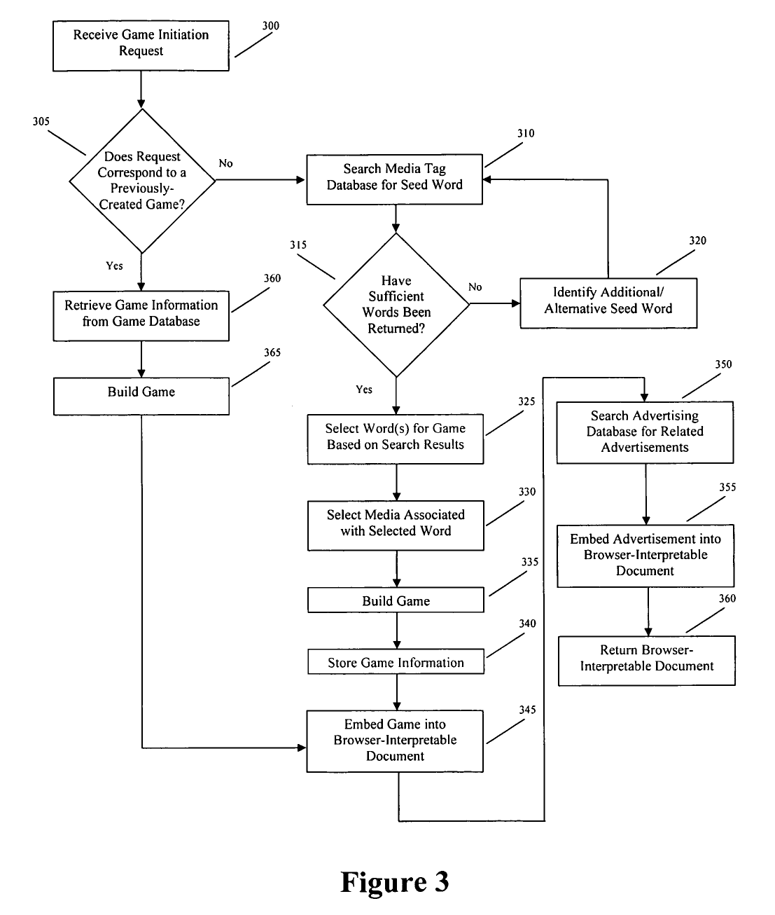

In some embodiments, game server 230 allows the user to store a previously created game. FIG. 3 is a flow chart illustrating an exemplary method by which a game can be initiated and/or created. In FIG. 3, when game server 230 receives a game initiation request (Block 300), game server 230 determines whether the request corresponds to a previously created game, or if it is a request that a new game be created (block 305). If the request is for a previously created game, the game information is retrieved from game database 231 (block 360). If necessary, as described below, the game is built (block 365) and the game is embedded into a browser interpretable document (block 345) for delivery to a network browsing application. In some embodiments, one or more advertisements, or pointers thereto, are also retrieved (block 350) and embedded into the browser interpretable document (block 355). For clarity, the term “advertisements” as used herein refers to both a file containing the advertisement and a pointer to the advertisement.

In FIG. 3, when game server 230 receives a game creation request, block 305 branches to block 310, in which media tag database 221 is searched for tags related to the seed word. Although used in the singular form for clarity, the term “seed word” is intended to include one or more words used as a basis for a game. In some embodiments, such as those leveraging the Flickr service, the set of related tags may be determined using the flickr.tags.getRelated method of the Flickr API. By way of example, without limitation, when game server 230 opens the URL shown in Table 1, below, which corresponds to a seed word of “zoo”, media server 220 can return the set of tags illustrated in Table 2.

TABLE 1
http://api.flickr.com/services/rest/?method=flickr.tags.getRelated&api_key
=xxxxxxxxxxxxxxxxxxxxxxxxxxxxxxxx&tag=zoo

TABLE 2

| <?xml version=“1.0” encoding=“utf-8” ?> | | <tag>reptile</tag> |
|---|---|---|
| | = <rsp stat=“ok”> | <tag>park</tag> |

| | |
|---|---|
| = <tags source=“zoo”> | <tag>primate</tag> |

| | |
|---|---|
| <tag>animal</tag> | <tag>panda</tag> |
| <tag>animals</tag> | <tag>polar</tag> |
| <tag>bird</tag> | <tag>peacock</tag> |
| <tag>nature</tag> | <tag>feathers</tag> |
| <tag>tiger</tag> | <tag>parrot</tag> |
| <tag>cat </tag> | <tag>baby</tag> |
| <tag>wildlife</tag> | <tag>aquarium</tag> |
| <tag>birds</tag> | <tag>fish</tag> |
| <tag>flamingo</tag> | <tag>eyes</tag> |
| <tag>monkey</tag> | <tag>black</tag> |
| <tag>lion</tag> | <tag>owl</tag> |
| <tag>water</tag> | <tag>mammal</tag> |

| | |
|---|---|
| <tag>bear</tag> | <tag>impressedbeauty</tag> |

| | |
|---|---|
| <tag>ape</tag> | <tag>portrait</tag> |
| <tag>giraffe</tag> | <tag>eagle</tag> |
| <tag>gorilla</tag> | <tag>closeup</tag> |
| <tag>specanimal</tag> | <tag>lioness</tag> |
| <tag>pink</tag> | <tag>eye</tag> |
| <tag>canon</tag> | <tag>penguin</tag> |
| <tag>elephant</tag> | <tag>leopard</tag> |
| <tag>green</tag> | <tag>beak</tag> |
| <tag>white<tag> | <tag>bw</tag> |
| <tag>zebra</tag> | <tag>d50</tag> |
| <tag>nikon</tag> | <tag>redpanda</tag> |
| <tag>bigcat</tag> | <tag>lizard</tag> |
| <tag>cute</tag> | <tag>tiere</tag> |
| <tag>wild</tag> | <tag>stripes</tag> |
| <tag>blue</tag> | <tag>naturesfinest</tag> |
| <tag>animalplanet</tag> | <tag>abigfave</tag> |

| | |
|---|---|
| <tag>meerkat</tag> | </tags> |

| | |
|---|---|
| <tag>animalkingdomelite</tag> | </rsp> |

<tag>polarbear</tag>
<tag>red</tag>

As can be seen in Table 2, the results returned by media server 220 include a plurality of tags related to the seed word. In some embodiments, the tags are arranged in order with the highest ranking tag appearing first. Tag rank may be determined based on a variety of factors, including, without limitation, the frequency with which the tag is associated with a media file with which the seed word is associated (e.g., clustered usage analysis), the number of times the tag has been the subject of a search within media tag database 221, or the like. In some embodiments, the tags with the highest scores are chosen. In some embodiments, tags with the lowest scores are chosen. In some embodiments, tags are chosen at random from the set of returned tags.

Tag selection may also be based on the type of game to be created. By way of example, without limitation, word find and crossword type games may be based on a matrix of a predefined size. Assuming that words can appear in the game diagonally, this size inherently limits the length of the tag that can be included in the game. The length of a diagonal word is bounded by the length of the shorter dimension of the matrix, i.e., min (l,w), where l is the length of the matrix, in letters, and w is the width of the matrix, in letters. In games in which the words cannot appear diagonally (e.g., traditional crossword type games), the tags may be limited to no more than the lesser of the length or width of the matrix. Similarly, tags comprising only words of only one or two letters may be eliminated as being too short. Tags may be chosen at random, or based on any of a number of factors, once undesirable tags have been eliminated from the set of tags.

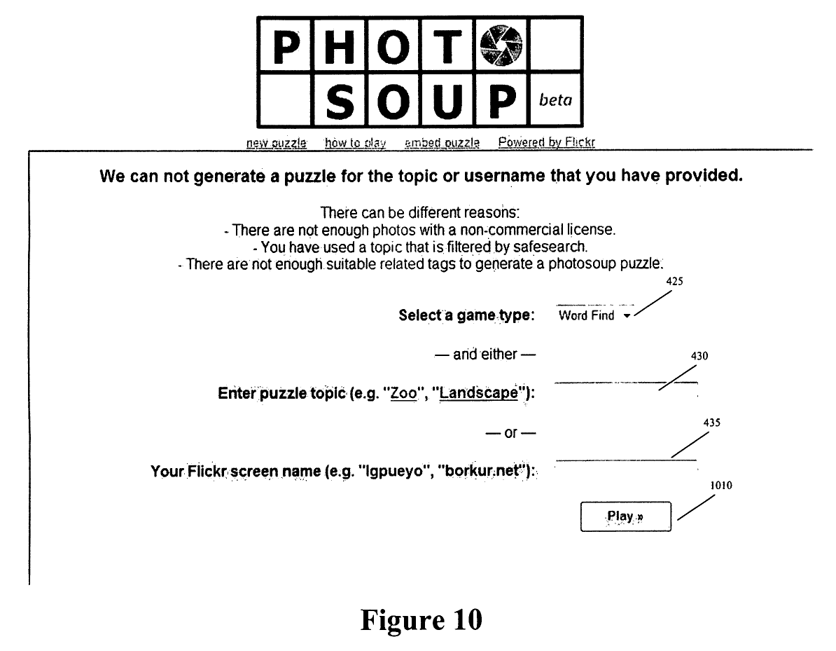

The number of tags chosen may be predefined based on the game type and other information available to the browser and/or game server 230. By way of example, without limitation, fewer tags may be selected, and a smaller matrix employed, by game server 230 when browser 212 reports that the game will be played on a screen having a VGA resolution than a screen having a QXGA resolution. In addition, some games, such as hangman, inherently use a limited number of tags/words during the game. Referring again to FIG. 3, if the number of tags returned as part of the original search, or the number of tags remaining after elimination of undesirable tags, is too small to create a game (block 315) game server 230 may present the user with a user interface similar to that of FIG. 10, in which the user is given the option to select a new game type from drop down 425, and either a seed word in field 430 or a screen name in field 435 (block 320).

Once a desired set of tags has been chosen (block 325), the game engine can select a media file to associate with each tag (block 330). In some embodiments, the game engine ensures that there is a one to one correspondence between the set of media files and the set of tags. That is, with the exception of the seed word, game server 230 ensures that only one media file in the set of media files has each of the selected tags.

In some embodiments, once the tags and media files have been selected, the game can be created (block 335). Although described herein and in FIG. 3 as occurring after both the media files and the tags are selected, it should be apparent to one skilled in the art that only the tags need to be selected before a game can be created.

To create a word find game, the matrix is populated with the selected tags. In some embodiments, tag/word orientation may be chosen based on a weighted average. That is, words may be assigned a horizontal, vertical, or diagonal orientation based on a given percentage, such as 45% horizontal, 45% vertical, and 10% diagonal. Once a tag has an orientation associated therewith, the word is placed in the matrix. In some embodiments, care is taken to prevent words from overlapping or intersecting with other words. In some embodiments, game server 230 may identify a word already on the matrix that is in a different orientation and that shares at least one letter with the word to be placed in the matrix. The word to be placed is then entered into the matrix such that it intersects the identified word. This allows for a tighter concentration of words in the game, and can result in more tags being fit within each game, which in turn increases the difficulty of the game. Once all tags have been placed within the matrix, any empty matrix portions are filled with random letters. In some embodiments, the letters may be chosen by a weighted average of the frequency in which various letters appear in the tags, thereby increasing the difficulty of the game for the end user.

In some embodiments, the crossword puzzle creation process can be similar to the process used to create a word find game. In some embodiments, the tags can be ordered based on the number of letters in the tag. Those having the most letters can be placed first in the matrix, with a location nearer the center typically being advantageous. For each remaining word, the matrix is searched a letter from the word that already exists in the matrix, and game server 230 ensures that no improper overlapping occurs. Once all tags have been placed within the matrix, the empty matrix positions are filled with a first color (e.g. black) and the matrix positions having a letter are filled with a second color (e.g., white), thereby creating a classic crossword puzzle appearance.

Once the game has been built, the user may be given the option to store the game. In some embodiments, the seed words, user ID's, and other information associated with the game may be stored, with the exact word choice, layout of the words, the selected media, and the like varying each time the game is played based on up-to-date statistical information. In some embodiments, the exact layout of the game, including the specific orientation and position of each word, the media selected, and the like, is all recorded as part of the saved game.

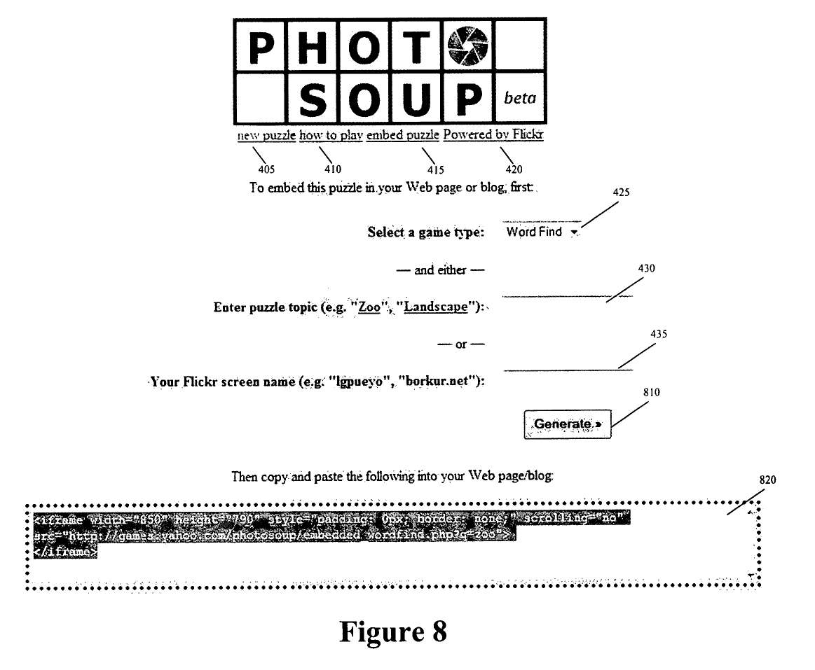

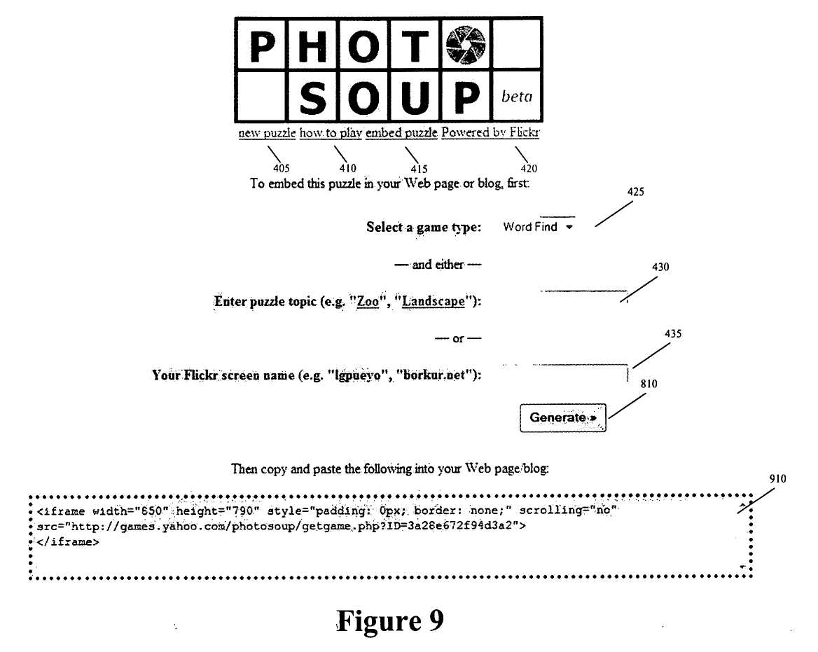

In some embodiments, game server 230 may allow the user to easily create a game, and present the user with HTML or other code which facilitates the embedding of the game into the user's own browser interpretable documents. By way of example, without limitation, the user may have a personal blog on a web site, and the blog may describe a recent vacation. The user may also make photographs of the vacation available via Flickr or other such service, and such a user may include a link to the vacation pictures in his or her blog entry. Game server 230 may also readily facilitate the inclusion of a word game into the user's blog by generating HTML or other code that can be copied by the user and pasted or otherwise inserted into the blog. FIGS. 8 and 9 illustrate this in more detail. In FIG. 8, the user selects the appropriate game type in drop down 425 and enters at least one of a seed word in field 430 or a screen name in field 435. By clicking or otherwise activating generate button 810, the user can request that game server 230 generate and the code that will allow the game to be incorporated into the user's blog. Field 820 illustrates exemplary code for embedding a dynamically generated word find game based on the seed word “zoo” in a blog or other browser interpretable document. Field 910 of FIG. 9 illustrates exemplary code for embedding a pre-configured game in a blog or other browser interpretable document. In such an embodiment, each pre-configured game is given a unique ID, by which the game can be retrieved from game database 231.

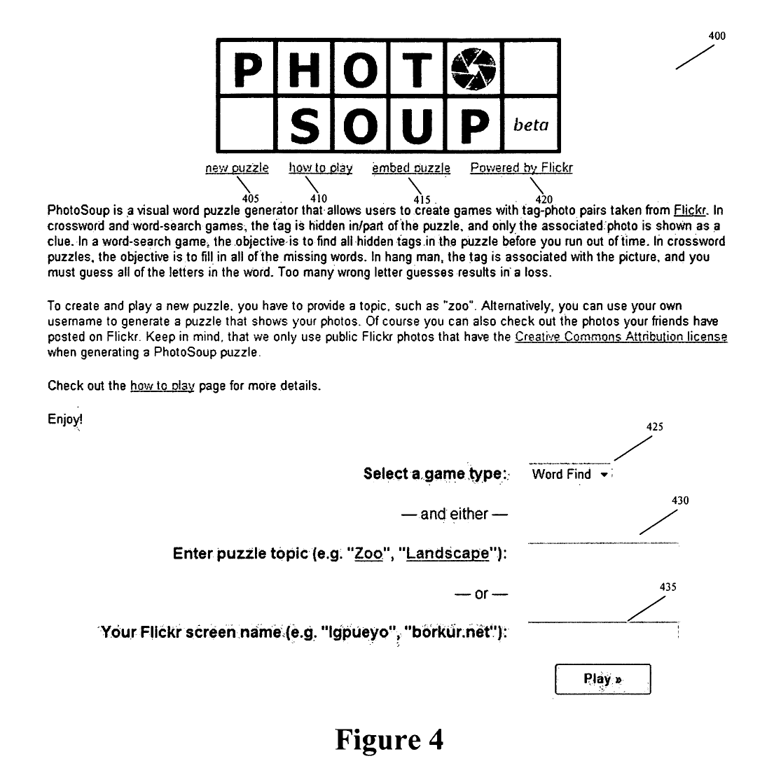

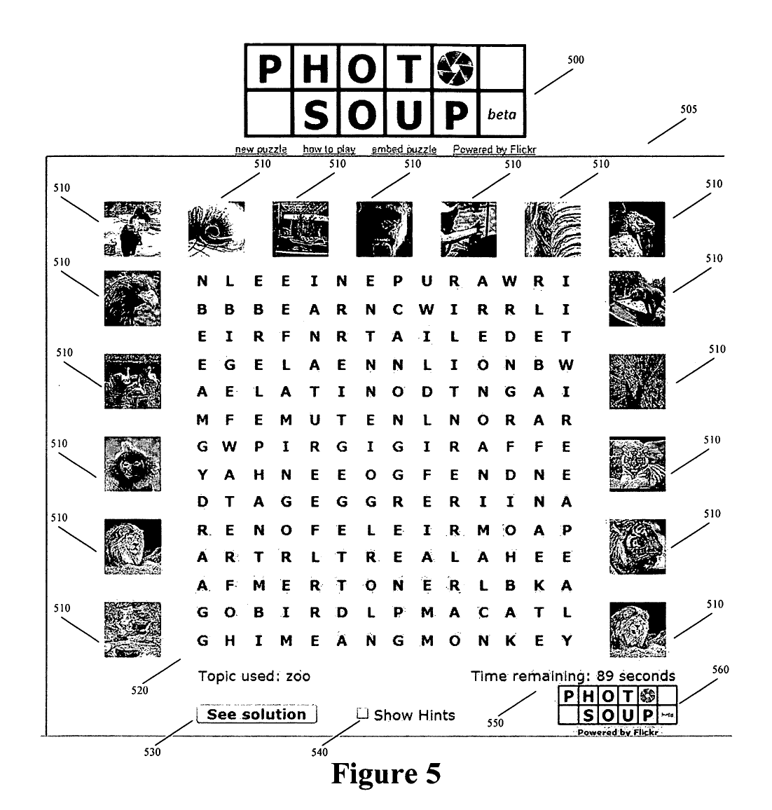

FIGS. 4 through 7 illustrate exemplary user interfaces presented to a user by browser 212 during the creation and play of a word find game. In FIG. 4, the user selects the game type from game type selector 425, and enters one of either a puzzle topic (i.e. seed word) into field 430, or a username into field 435, and a new game is created and displayed as word find game 505 of FIG. 5, along with advertisement 500, and sponsor identifier 560. As use herein, the term “seed value” is intended to include both seed word and usernames when used as a basis for creating a game.

In FIG. 5, matrix 520 is populated in accordance with the methods described above. Media files 510 are displayed around the periphery of the matrix, and can provide clues about the respective tag/word hidden in the matrix. Although illustrated as static images, media files 510 may be any sensory stimulating content, including, without limitation, static and moving images, sounds, scents, and tactile/haptic feedback. In some embodiments, the user is given a pre-set period of time (e.g., 90 seconds) in which to find a first tag hidden in the matrix (see timer 550). In some embodiments, time is added as each additional tag is found. In some embodiments, the amount of time added may vary depending on the time that elapses between each successful tag identification—the longer the delay, the less time that is added. In some embodiments, the amount of time added may also vary depending on the amount of time remaining.

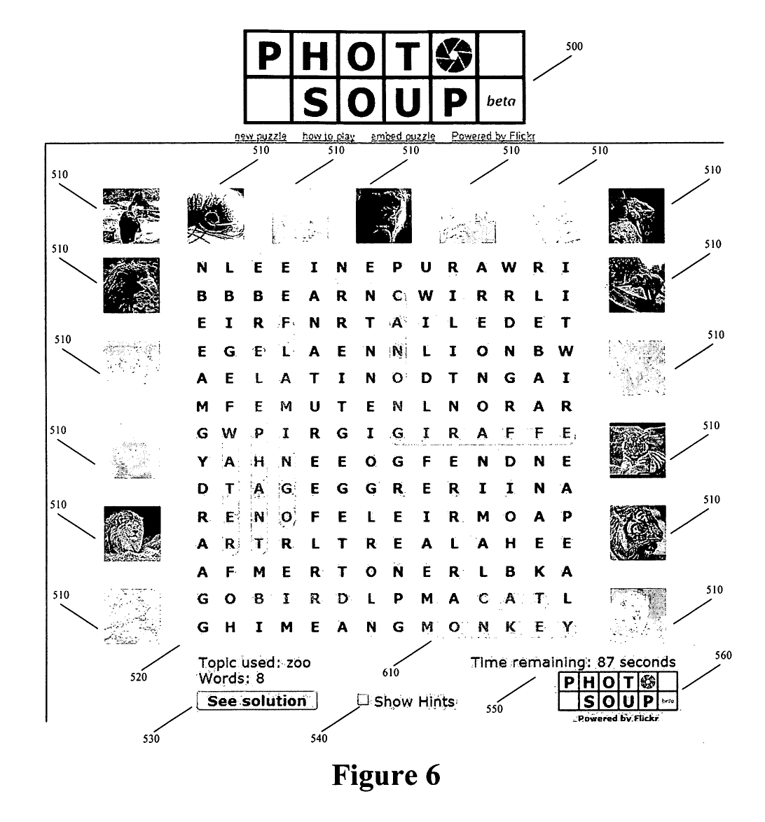

FIG. 6 is a screen capture of the game of FIG. 5 as it is being played by a user. As the user highlights the tags/words in the game (e.g. “monkey” 610), the corresponding media is hidden or otherwise positively indicated such that the user knows that the corresponding word/tag has been found.

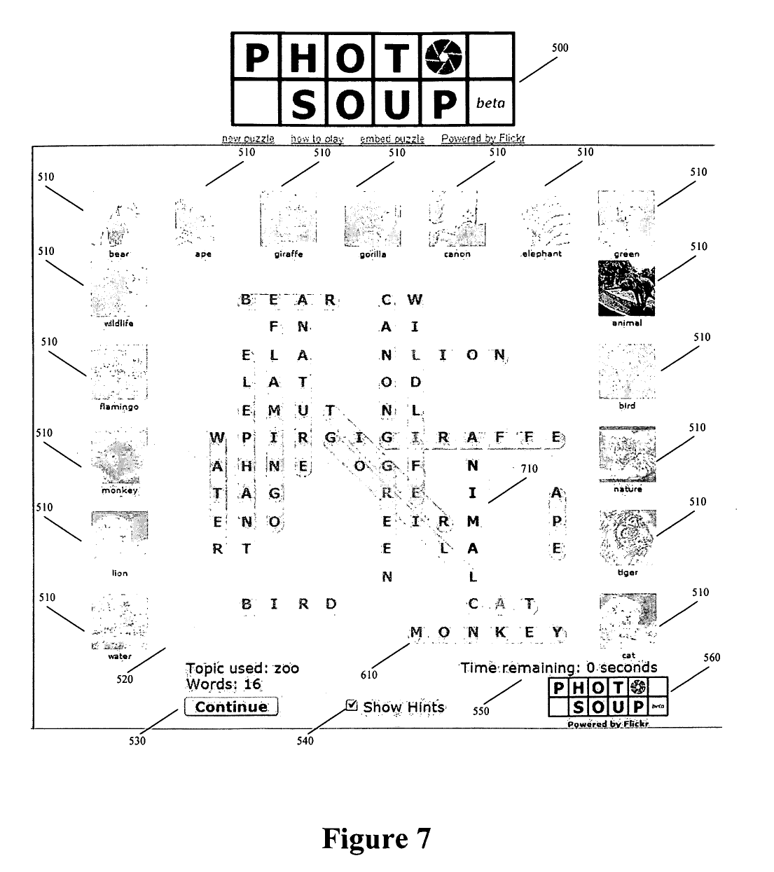

FIG. 7 is a screen capture of the game of FIGS. 5 and 6 after time has expired. As illustrated, any letters not part of a word/tag hidden in the matrix are removed, thereby allowing the user to see any unfound words (e.g. “animal” 710). FIG. 7 also illustrates the activation of “show hints” option 540. When show hints 540 is enabled, the corresponding tag/word is displayed under each media file 510.

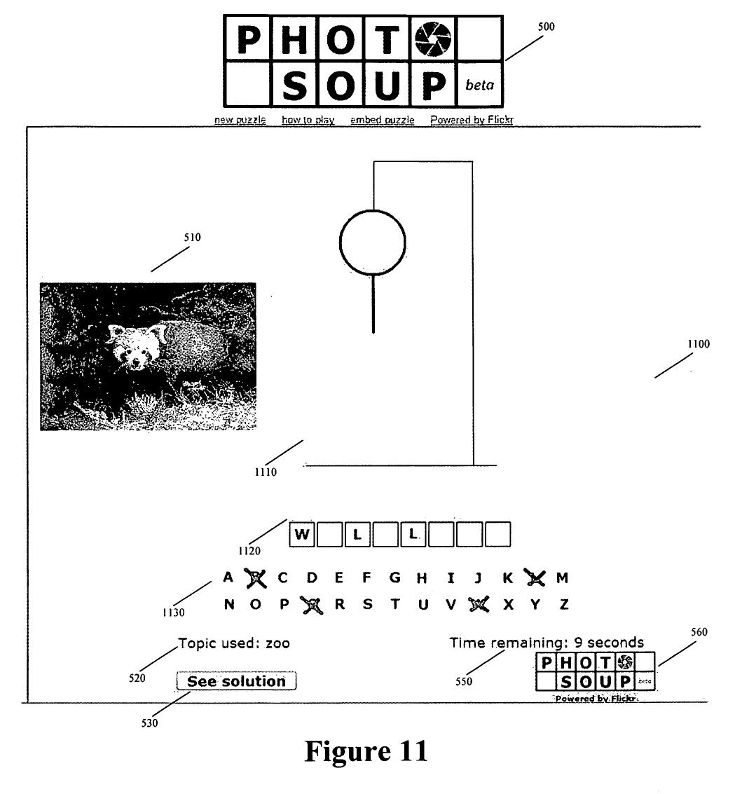

FIG. 11 is a screen capture illustrating an exemplary hangman game 1100 during the playing of the game. Word 1120 is illustrated as a series of blanks, one for each letter in the tag/word corresponding to media file 510. In FIG. 11, as the user clicks on or otherwise selects a letter from alphabet 1130, the letter is grayed out, crossed out, or otherwise positively identified to the user as having been previously selected. If the selected letter is part of word 1120, the letter appears at each appropriate location within word 1120. If the selected letter is not part of word 1120, an additional attribute is added to character 1110. If all character 1110 attributes have been added before word 1120 is complete, the game ends. In some embodiments, an additional attribute is added to character 1110 each time timer 550 expires, with timer 550 resetting each time a new letter is selected.

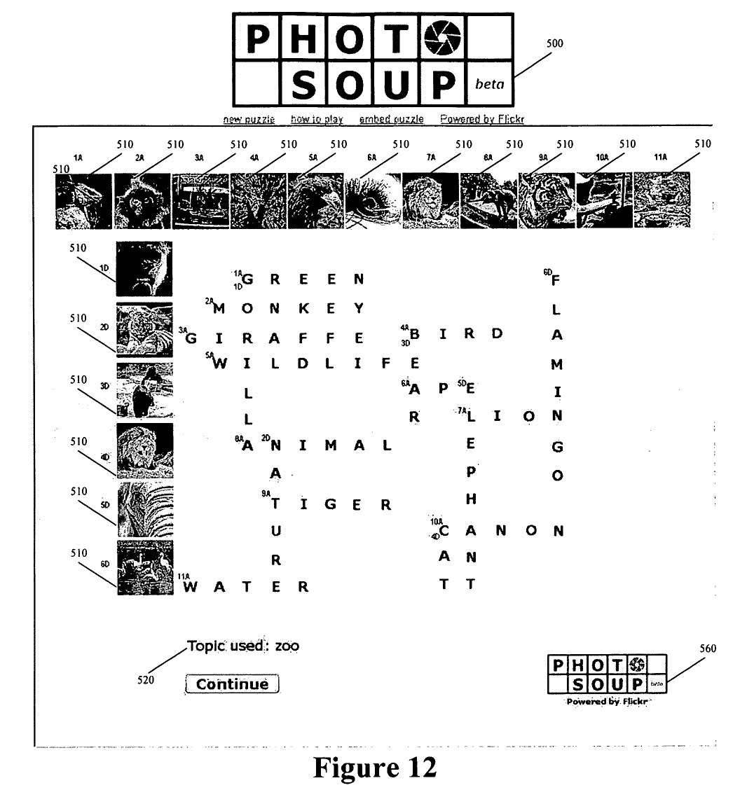

FIG. 12 is a screen capture illustrating an exemplary crossword puzzle game at the completion of the game.

While detailed and specific embodiments of the media tag game engine have been described herein, it will be apparent to those skilled in the art that various changes and modifications can be made therein without departing from the spirit and scope of the media tag game engine. Thus, it is intended that the present disclosure cover these modifications and variations provided they come within the scope of any appended claims and/or their equivalents.

What is claimed is:

1. A method of creating a word game, comprising:
receiving a seed value from a browser running on a user computer;
obtaining from a media database a plurality of words associated with the seed value;
creating a word game from at least a subset of the obtained plurality of words;
integrating the word game into a browser interpretable document; and,
returning the browser interpretable document to the browser.

2. The method of claim 1, further comprising:
obtaining an advertisement from an advertising server; and,
integrating the advertisement into the browser interpretable document.

3. The method of claim 2, the advertisement being associated with the seed value.

4. The method of claim 2, the advertisement being associated with at least one of the obtained plurality of words.

5. The method of claim 1 further comprising:
obtaining a media file for each of the at least a subset of the obtained plurality of words used in the word game; and,
integrating the obtained media files into the word game as a clue.

6. The method of claim 1, further comprising:
selecting a specific number of words from the obtained plurality of words;
arranging the selected words within a matrix;
filling in the matrix with random letters; and,
storing the filled matrix for display via the browser.

7. The method of claim 6, the selected words being arranged such that they do not overlap.

8. The method of claim 1, further comprising:
selecting a specific number of words from the obtained plurality of words;
arranging the selected words within a matrix;
hiding any unfilled portions of the matrix;
storing the arrangement of the filled portions of the matrix for display via the browser.

9. The method of claim 1, the seed value comprising a seed word.

10. The method of claim 1, the seed value comprising a username.

11. Computer program process code, tangibly stored on a computer readable medium, the computer program process code comprising instructions interpretable by a processor, the instructions comprising:
receiving a seed value from a browser running on a user computer;
obtaining from a media database a plurality of words associated with the seed word;
creating a word came from at least a subset of the obtained plurality of words;
integrating the word game into a browser interpretable document; and,
returning the browser interpretable document to the browser.

12. The computer program process code of claim 11, the instructions further comprising:
obtaining an advertisement from an advertising server; and,
integrating the advertisement into the browser interpretable document.

13. The computer program process code of claim 12, the instructions causing the selection of an advertisement associated with the seed word.

14. The computer program process code of claim 12, the instructions causing the selection of an advertisement associated with at least one of the obtained plurality of words.

15. The computer program process code of claim 11, the instructions further comprising:
obtaining a media file for each of the at least a subset of the obtained plurality of words used in the word game; and,
integrating the obtained media files into the word game as a clue.

16. The computer program process code of claim 11, the instructions further comprising:
selecting a specific number of words from the obtained plurality of words;
arranging the selected words within a matrix;
filling in the matrix with random letters; and,
storing the filled matrix for display via the browser.

17. The computer program process code of claim 16, the instructions causing the selected words to be arranged such that they do not overlap.

18. The computer program process code of claim 11, the instructions further comprising:
selecting a specific number of words from the obtained plurality of words;
arranging the selected words within a matrix;
hiding any unfilled portions of the matrix;
storing the arrangement of the filled portions of the matrix for display via the browser.

19. The computer program process code of claim 11, the seed value comprising a seed word.

20. The computer program process code of claim 11, the seed value comprising a username.

21. A system comprising:
a gaming server, the gaming server receiving a request for a game from a browser running on a user computing device, the request comprising a seed value;
a media server, the media server comprising a media tag database, the media tag database having stored therein a plurality of media tags;
the gaming server requesting a set of media tags associated with the seed value and building a word game using at least a subset of the media tags and transmitting the word game to the browser as a browser interpretable document.

22. The system of claim 21, further comprising:
an advertisement server comprising an advertisement database, the advertisement server providing an advertisement to the gaming server;
the gaming server integrating the advertisement into the browser interpretable document.

23. The system of claim 22, the advertisement being selected by the advertisement server because it is associated with the seed value.

24. The system of claim 22, the advertisement being selected by the advertisement server because it is associated with at least one of the obtained plurality of words.

25. The system of claim 21, the media server further providing a media file for each of the at least a subset of the obtained plurality of words used in the word game; and
the gaming server integrating the obtained media files into the word game as a clue.

26. The system of claim 21, the word game being a hidden word game.

27. The system of claim 26, the hidden words being arranged such that they do not overlap.

28. The system of claim 21, the word game being a crossword puzzle.

29. The system of claim 21, the seed value comprising a seed word.

30. The system of claim 21, the seed value comprising a username.
